(19) United States
(12) Patent Application Publication
(10) Pub. No.: US 2018/0005539 A1
(43) Pub. Date: Jan. 4, 2018

(54) CUSTOM EDUCATIONAL DOCUMENTS

(71) Applicant: Hewlett-Packard Development Company, L.P., Fort Collins, CO (US)

(72) Inventors: Udi CHATOW, Palo Alto, CA (US); Georgia KOUTRIKA, Palo Alto, CA (US); Lei LIU, Palo Alto, CA (US)

(21) Appl. No.: 15/545,024

(22) PCT Filed: Jan. 20, 2015
(86) PCT No.: PCT/US2015/012068

§ 371 Date: Jul. 20, 2017

(51) Int. Cl. G09B 5/12; G06F 17/30; G09B 5/02; G09B 7/00

(52) U.S. Cl. CPC G09B 5/12; G09B 7/00; G06F 17/30014; G09B 5/02; G09B 5/125

(57) ABSTRACT

Example implementations disclosed herein can be used to generate student user-specific customized hybrid educational documents. Such implementations include systems, methods, and devices for determining an attention span profile associated with a particular student user, and generating a custom educational document in response to the attention span profile. Student user experience feedback and test results determined from the use of the customized educational document can be assessed to update the student user's attention span profile. The updated student user attention span can then be used to update the customized educational document.

### BACKGROUND

Educational content can be presented to student users in various media and formats. For example, educational content can be presented in the form of printed media that includes text, images, diagrams, and the like. To further enhance the educational experience, some educational material can be presented as passive or interactive multimedia content that can include not only text and images, but also video, animations, guided activities, and the like. Such interactive multimedia content can be provided in the form electronic data rendered by a computing device (e.g., laptop computer, a tablet computer, smartphone, etc.). Such educational content is generally referred to as electronic media or content.

Some educational materials pair printed media with electronic media to provide a more interactive or immersive learning experience. For instance, textual content, either hardcopies or electronic copies, can be intermixed with links (e.g., hyperlinks, URLs, or QR codes) that can be used to load or access the electronic media using a computing device. Such hybrid educational materials are useful for addressing the educational needs of different types of learners.

### BRIEF DESCRIPTION OF THE DRAWINGS

FIG. 1 illustrates an example of a hybrid educational content.

FIG. 2 illustrates an example of printed hybrid educational document with custom section lengths of educational content text and intervention point content, according to the present disclosure.

FIG. 3 illustrates an example of electronic hybrid educational document with custom section lengths of educational content text and intervention point content, according to the present disclosure.

FIG. 4 is a schematic of an example hybrid learning customizer system for generating student user specific customized hybrid educational documents.

FIG. 5 depicts an example data flow for generating student user specific customized hybrid educational documents.

FIG. 6 depicts example standardized attention span profiles and student user attention span profile records.

FIG. 7 is a flowchart of an example method for generating student user specific customized hybrid educational content, according to the present disclosure.

### DETAILED DESCRIPTION

Overview

The present disclosure describes techniques for systems, devices and methods for generating customized hybrid educational documents based on individual assessment of a student users attention span. In one particular implementation, a student user attention span profile can be generated based on various student user specific input data. As used herein, the term “student user” is used to refer to any user who can use the educational documents to learn about a particular topic or academic subject.

In some examples, a student user attention span profile can be based on a self-reported estimate of the student user's attention span. In other examples, the student user attention span profile may also be based on, or take into account, an instructor-reported assessment of the student user's attention span, and/or analysis of results from an attention span test completed by the student user. For example, a student user may self-report that his or her attention span while reading a particular subject (e.g. science, history, social science, etc.) is approximately 10 minutes. The student user's instructor (e.g. teacher, tutor, professor, etc.) may report that that particular student user's attention span is five minutes for the particular subject. Implementations of the present disclosure can also include reading comprehension and retention tests specifically designed to analyze the particular student user's attention span for reading text in the particular subject.

In addition to the self-reported and instructor-reported assessments of the student user's attention span and reading comprehension and retention test results, other data specific to the particular student user can also be considered. In various example implementations, the student user's age, grade level, diagnosed educational disabilities, and other academic characteristics can be used as the student user specific input used to generate the student user's attention span profile.

As described herein, the student user attention span profile can include any or all of the raw or processed student user attention span assessment input data and reference standardized attention span profiles. Accordingly, the student user attention span profile can include information that various implementations can use to generate custom hybrid educational material.

For example, a student user attention span profile may reference a standard or average grade level attention span profile that includes an attention span time and other reading characteristics (e.g. third grade students when reading at approximately 60 words per minute typically have 5 to 7 minutes of effective reading attention span while reading history text books). The standard grade level attention span profile can then be altered based on other information in the student user attention span profile. For example, a particular student user may read slower than is average for their grade level or age bracket. In such cases, the reading characteristics relating to the reading speed can be altered to determine reading sections in the resulting hybrid educational document that a particular student user will be able to complete within the time frame of the associated attention span.

In the following detailed, description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, physical network, virtual network, and/or organizational changes can be made without departing from the scope of the present disclosure.

Hybrid Educational Documents

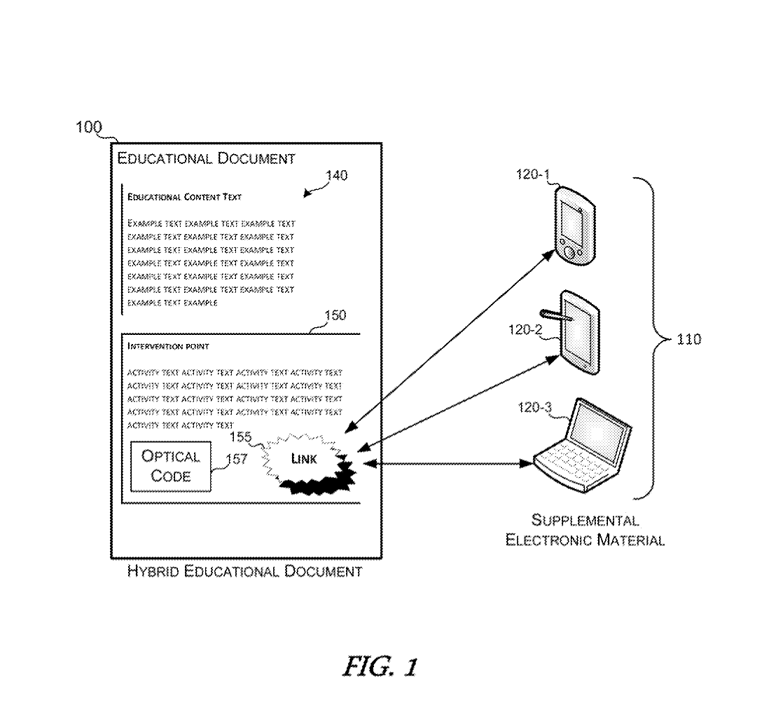

Example implementations of the present disclosure are described in the context of generating custom hybrid educational documents based on student user specific attention span profiles. As described herein, hybrid educational documents, such as educational document 100 depicted in FIG. 1, may include a combination content types. For example, educational document 100 may include educational content text 140. Such educational content text 140 can include detailed written descriptions or explanations of specific subject matter. For instance, the educational content text 140 may include a detailed account of historical events in a history text book, or instruction as to how to use mathematical functions to solve a scientific problem. Hybrid educational document 100 may include physical documents (e.g., printed pages or books) or electronic documents (e.g., visual renderings based on computer readable code or files).

To enhance the educational value of the educational content text 140, the hybrid educational document 100 may also include various intervention points 150. In some implementations, intervention point 150 can include any combination of activity text, discussion text, test text, and the like, that promotes interactivity with the subject matter of the educational content text 140. For example, the activity text may ask the student user to analyze or apply the subject matter discussed in the preceding educational content text 140. In other implementations, the intervention point 150 can include test or quiz questions that the student user can attempt to answer based on their understanding or comprehension of the educational content text 140.

In yet other implementations, the intervention point 150 may also include indications of supplemental electronic material 110 accessible to the student user through various types of computing devices 120. For example, the intervention point 150 can include an optical code 157, such as a QR code, a barcode, a watermark that is readable by a computing devices 120. Based on the interpretation of the optical code 157, a computing device 120 can access local or remotely stored (e.g., webpages) supplemental electronic materials 110. In similar implementations, the intervention point 150 can include a link 155. For example, link 150 can include a printed representation of a file address or universal resource identifier (URL) that a student user can input into a computing device 120 to access the supplemental electronic material 110.

As described herein, the supplemental electronic material 110 can include any combination of interactive or passive multimedia content. For example, the supplemental electronic material may include a text-based or video-based quiz to evaluate the student user's comprehension of the educational content text 140. In other examples, the supplemental electronic material 110 may also include multimedia games, videos, or instructions for performing an activity to reinforce or reiterate the subject matter or concepts described in the educational content text 140. Such intervention points are helpful for refocusing or recapturing the student user's attention after reading some portion of the entirety of the educational contents text 140.

While hybrid educational documents, such as the educational document 100 described in reference to FIG. 1 above, can be effective tools for teaching student users various types of subject matter, not all student users can or will internalize the subject matter of the educational content text 140 in the same way.

In particular, the attention span capabilities of individual student users or groups of student users can vary. For example, one student user may have an attention span long enough to be able to read very long sections of educational content text 140 with good comprehension and retention. On the other hand, another student user may have a much shorter attention span. Accordingly the student user with the shorter attention span may have difficulty internalizing subject matter presented in long sections of educational content text. To address the specific educational needs of student users with varying attention spans, implementations of the present disclosure can include generating custom hybrid educational documents with educational content text sections of varying lengths specific to a particular student user or group of student users.

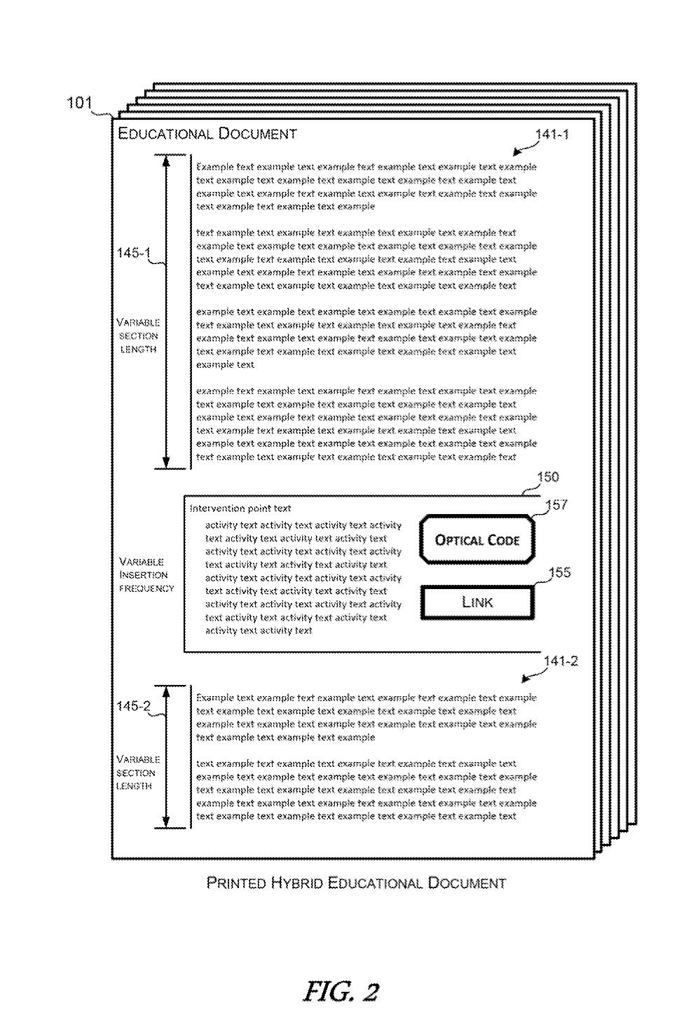

FIG. 2 depicts a printed customized hybrid educational document 101, according to various implementations of the present disclosure. As shown, the customized printed hybrid educational document 101 can include multiple sections 141 of the educational content text 140. The length 145 of the sections 141 can vary based on the attention span profile for a particular student user. In related implementations, the length 145 of a particular section 141 can also vary based on the reading capabilities (e.g,, the student user's word per minute reading speed) and/or the difficulty of the writing style (e.g., reading level) or subject matter presented in the educational content text 140. Thus, the specific variable section length 145 of a section 141 of educational content text 140 can be determined based on the amount of text or subject matter that a particular student user can read, comprehend, and/or retain within that student user's associated attention span.

In some implementations, the content of the intervention point 150 may also be based on the attention span and other academic characteristics of the specific student user for whom the printed customized hybrid educational document 101 is generated. For example, a particular student user may be identified as being a visual learner who learns best using visual representations, graphics, images, video, and the like. For such a student, the intervention point 150 may include activity text, or an optical code 157 or a link 155 to supplemental educational material with appropriate visual learning content. For example, the activity text may instruct the student user to illustrate an aspect or concept from the preceding section 141 of educational content text 140. In some example implementations, the optical code 157 or link 155 may be associated with a video or animation that offers an additional explanation or a reinforcing summary of the concepts discussed in the educational content text 140 in preceding section 141. For a student user identified as being an aural learner, the activity text of the intervention point 150 may instruct them to discuss the content of the educational content text 140 with another student, while the optical code 157 and/or link 155 may be associated with audio content (e.g., the recording of a lecture, commentary, music, etc.) with additional explanations, demonstrations, or pneumonic techniques that the student user can use to understand the subject matter of the preceding section 141 of educational content text 140

In other embodiments, the intervention point 150 may also include mechanisms for evaluating the student user's comprehension and retention of the section 141 of the educational content text 140 with the corresponding length 145. For example, the intervention point 150 can include an interactive test specifically designed to evaluate how well the student user understood and internalized the subject matter of the preceding section 141 of the educational content text 140. Various implementations of the present disclosure can use the results of the tests in the intervention points 150 to further refine the variables section lengths 145 of subsequent sections 141 of educational content text 140. For example, if the test results indicate that the student user is easily grasping and retaining the subject matter of the previous section 141 of a particular length 145, then subsequent educational content text 140 may be presented in sections 141 of corresponding longer lengths 145. In contrast, if the test results indicate that the student user's attention span is waning before the end of the preceding section 141, the length 145 of subsequent sections 141 may be shortened.

Various implementations of the present disclosure may also include varying the frequency and/or type of intervention points 150 among sections 141 of the educational content text 140. The frequency and/or type of activities or content included in the intervention points 150 can be based on the attention span and/or other academic characteristics of a particular student user.

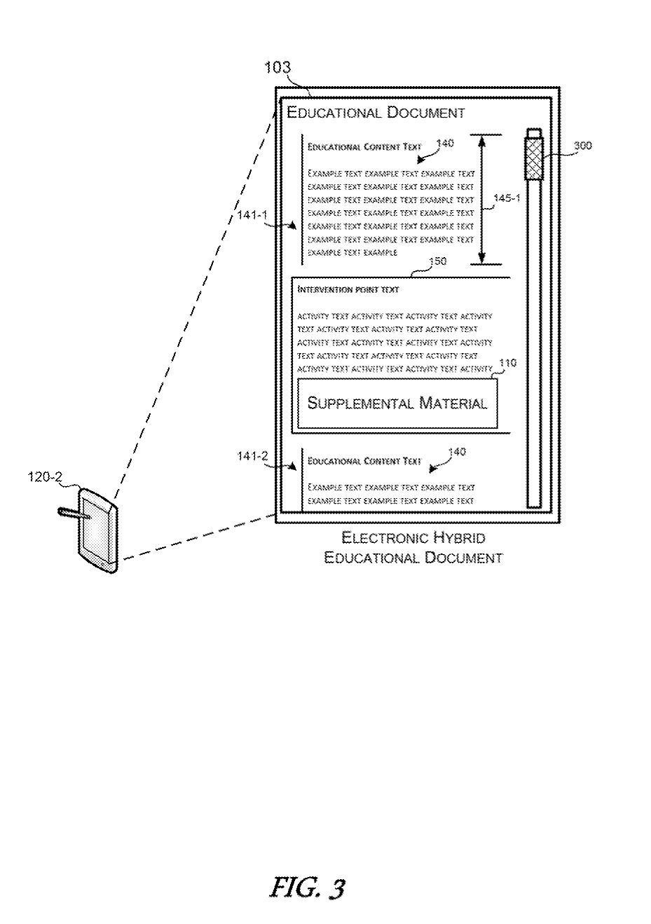

FIG. 3 depicts an electronic version of a customized hybrid educational document 103 viewed on a computing device 120, such as tablet computer 120-2. In such implementations, the customized hybrid educational document 103 can be rendered on a display device of the computing device 120. Accordingly, the educational content text data, supplemental material data, and the layout of the educational content text and/or the associated supplemental material 110 can be included in a computer readable file accessible to the computing device 120. In addition to the content of the electronic customized hybrid educational document 103, the computing device 120 may also render controls, such as slider bar 300, for navigating the sections 141 of the educational content text 140 and intervention points 150.

In some example customized electronic hybrid educational documents 103, the supplemental material 110 can be embedded directly into the intervention points 150. Accordingly, multimedia material, such as video, audio, interactive activities, and the like can be presented to the student user directly within the intervention point 150 region. Alternatively, multimedia material for the supplemental material 110 can launch in a separate window or frame rendered in superimposition or separately from the depiction of the electronic customized hybrid educational document 103. For example, a video of an animation with explanations that reinforce or reiterate the concepts introduced in the preceding section 141 of the educational content text 140 can be displayed within the confines of intervention point 150 or in a new browser window. In any such implementations, electronic data or files that the computing device 120 uses to render the supplemental material 110 can be stored locally in a volatile or non-volatile storage device in the computing device 120 (e.g. on a hard drive, solid-state drive, flash memory, etc.) or remotely on a server computer or website (not shown).

Hybrid Learning Customizer System

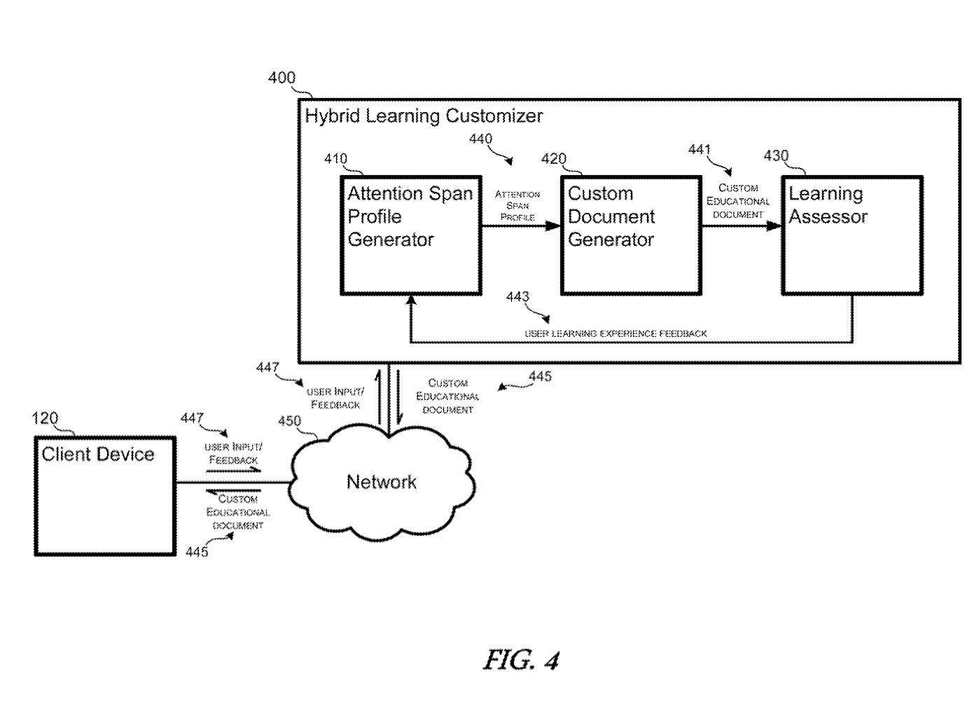

FIG. 4 is a schematic representation of a hybrid learning customizer system 400 for generating custom hybrid educational documents, according to examples of the present disclosure. In various examples, the hybrid learning customizer 400 can be implemented as a combination of software and hardware in one or more computing devices. For example, a hybrid learning customizer 400 can be implemented as computer executable code stored in a volatile or nonvolatile memory in a server computer. Alternatively, the hybrid learning customizer 400 can be implemented in an instance of a virtual server computer in a cloud computing environment. Accordingly, the hybrid learning customizer 400, and any of its component functionality, can be embodied as computer executable code that include instructions, that when executed by a processor in a computing system, cause the processor to be configured to perform the functionality described herein.

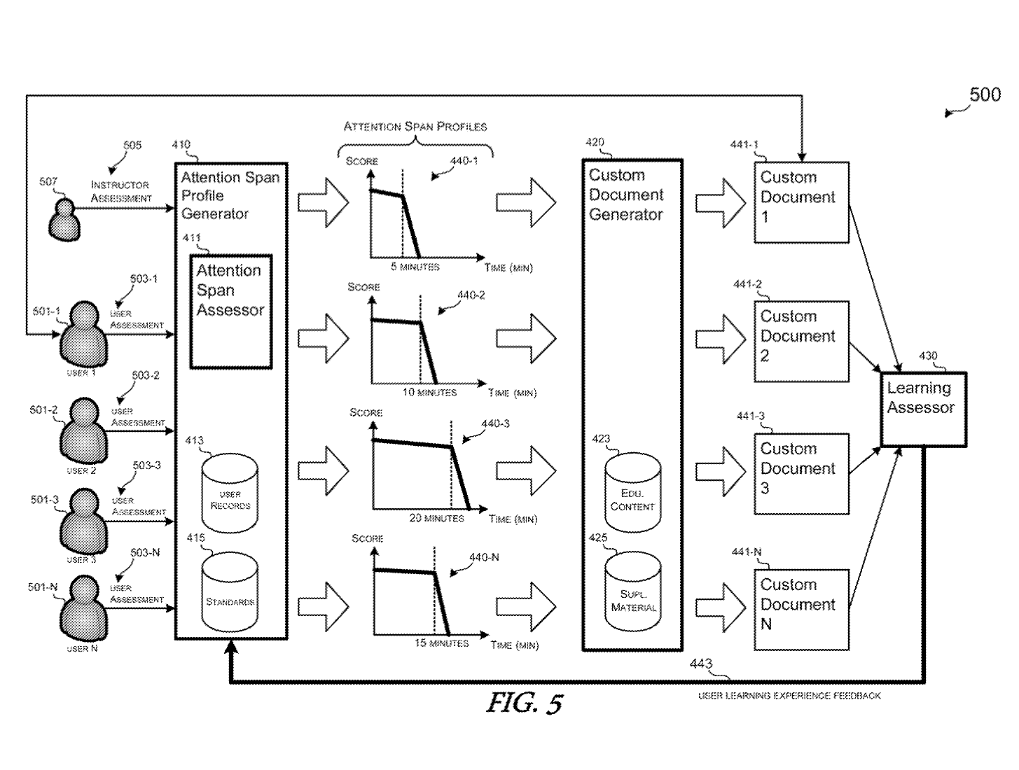

As shown, hybrid learning customizer 400 can include various components. In the particular example shown, the hybrid learning customizer 400 can include an attention span profile generator 410, a custom document generator 420, and a learning assessor 430. The functionality of the hybrid learning customizer 400 and its components are discussed in more detail below in reference to the schematics and data flows depicted in FIG. 4 and FIG. 5.

In one example, the attention span profile generator 410 can receive input regarding the actual or expected academic capabilities and/or attention span of a particular student user. For example, the attention span profile generator 410 can receive information reported by the student user or an instructor associated with the student user regarding the student user's attention span. The attention span of a particular student user can be classified or scored in terms of the amount of time (e.g. the number of minutes) that a student user can effectively read educational content with some threshold level of retention and comprehension of the subject matter contained in educational content text. The attention span for a particular student user can also be associated with a particular academic subject. For example, the attention span for one particular student user may be longer for educational subject matter pertaining to history than it is for educational subject matter related to physical or life sciences. Accordingly, the particular student user may be associated with multiple attention spans corresponding to their level of interest or academic prowess in a particular academic subject.

In addition to the self-reported or instructor-reported attention span information, the attention span profile generator 410 can also analyze test results administered to the student user to determine an attention span. For example, the attention span profile generator 410 can include or access attention span assessment tests and provide them to the client device. Using a client device 120, the student user can access the tests. The student user can complete the tests while logged onto the hybrid learning customizer 400 (e.g., web-based testing) and/or download the attention span assessment test, complete the test offline, and then later logon to the hybrid learning customizer 400 to upload the results of the test.

As described above, an attention span can be associated with a particular academic subject, such that the attention span for a particular student user for one subject may differ from an attention span for that same student user in another subject. As such, the attention span assessment tests can be associated with or pertain to a particular academic subject. In various examples, the student user can select or the attention span profile generator 410 can determine a particular attention span assessment test based on the academic subject matter of the hybrid educational content document to be generated. For example, if the subject matter of the hybrid educational document to be customized includes educational content text regarding mathematics, then the attention span profile generator 410, the student user, or the student user's instructor can select an attention span assessment test specifically designed to determine the attention span of a student user while reading mathematical educational text.

Based on the input regarding the particular student user's attention span, the attention span profile generator 410 can generate the attention span profile 440. The attention span profile 440 can include information regarding a particular student user's attention span for reading educational content text in various specific subjects. In some implementations, the attention span profile 440 can include a duration of time that the student user can be expected to effectively concentrate on the educational content text. In other implementations, the attention span profile 440 can include data regarding the student user's expected understanding, comprehension, and/or retention of the subject matter presented in the educational content text as a function of time. In such implementations, the attention span of a particular student user associate with a particular subject can be determined as the time point or time range at which the level of comprehension and/or retention of the subject matter falls below a predetermined or dynamically determined threshold level The attention span profile 440 may also include other academic characteristics of the student user, such as reading speed, grade level, age, indications of actual or potential learning disabilities, and the like.

Based on the attention span profile 440, the custom document generator 420 can generate a custom conventional or hybrid educational document 441 that includes educational content from another source, such as a textbook. As described herein, the educational documents can include sections 141 of educational content text 140 having variable lengths 145 determined for the particular student user. For example, the lengths 145 of sections 141 can be compiled to include the correct amount of educational content text that the student user can be expected to be able to complete within a range of time approximately equal to an expected attention span in the attention span profile.

The learning assessor 440 can then provide the custom educational document 441 to a student user through the network 450 (e.g., a LAN, WiLAN, WAN, the Internet etc.) and the client device 120. In such implementations, the custom educational document 441 can include electronic custom educational documents 445. Client device 120 can either render the received custom educational document 445 or cause an integrated or external printer device (not shown) to generate a hard copy of the custom educational document 445. In either such implementations, the student user can use the custom educational document 400 by reading the sections 141 of the educational content text 140 and/or actively or passively using the text or supplemental electronic material in the intervention points 150.

Based on the student users experience using the custom educational document 445, the client device 120 can return student user input/feedback 447 through the network 450 to the hybrid learning customizer 400. As described herein, the supplemental materials 110 can include interactive activities that generate comprehension and/or retention results corresponding to the preceding section 141 of educational content text 140. Such interactive activities can include multiple choice tests, games, and the like, the results of which can be interpreted or analyzed to determine how well the student user understood the educational content text 140 in the preceding section 141.In some implementations, the student user input/feedback 447 can include test or quiz results resulting from the use of the supplemental materials 110 of the custom educational document 445.

The learning assessor 430 can anal?, the custom educational document 441 in view of the student user input/feedback 447 to generate student user learning experience feedback information 443. Thus, if the student user is determined to have had difficulty comprehending and/or retaining the educational material of the educational content text 140 in a section 141 having a length 145, then the attention span profile generator 410 can update the attention span profile 440 for that particular student user. For example, the attention span profile generator 410 can reduce the length of the attention span in which the student user can be expected to effectively comprehend or retain the subject matter in the educational content text 140. As a consequence, the custom document generator 420 can reduce the length 145 of the sections 141 in the subsequent editions, versions, sections, or session of the updated custom educational document 441.

On the other hand, if analysis of the student user input/feedback 447 indicates to the learning assessor 430 that the student user is not challenged by the length 145 of the sections 141 of the educational content text 140, the attention span profile generator 410 can increase the time period of the attention span for the student user in the updated attention span profile 440. Accordingly, the custom document generator 420 can increase the length 145 of the sections 141 in the updated custom educational document 441.

FIG. 5 depicts a detailed view of the data flow 500 among the various student users and components of the hybrid learning customizer system 400. As described in reference to FIG. 4, each student user 501 can input a self-reported student user assessment 503 into the attention span profile generator 410.

A student user 501 can use a client device 120 to access the hybrid learning customizer 400 through network 450. In such implementations, the hybrid learning customizer 400 may be hosted on a Web server accessible to the client device 120 through the network 450. The Web server may include functionality for providing a webpage to the client device 120 through which the student user 501 can create or access a student user account and input self-reported attention span scores, grade level, academic capabilities, academic subject interests, academic subject strengths and weaknesses, learning disabilities, and the like. The attention span profile generator 410 may also include functionality for administering or providing testing materials to a student user for assessing the student user's attention span. The results of the testing materials can be used by the attention span assessor as one input in determining the attention span profile 440.

In a related implementation, an instructor user 507 may also access the hybrid learning customizer 400 to input corresponding instructor-reported assessments 505 of student user attention spans for the student users 501. For example, the instructor user 507 may be the teacher for a classroom of student users 501. The instructor-reported attention span assessments 505 can include information that the instructor user 507 determined by evaluating the academic performance or reading attention spans of each of the individual student users 501. The instructor-reported attention span assessments 505 can override or augment the information provided in the self-reported student user assessments 505. Accordingly, instructor user 507 can correct or audit information reported by the student users 501 in their corresponding self-reported student user attention span assessments 503.

The self-reported attention span assessments 503 and the instructor-reported attention span assessments 505 can be stored in student user specific student user records 413. The attention span assessor 411 can reference the student user records 413 to generate an initial or updated attention span profile 440 for a specific student user 501.

In some implementations, the attention span assessor 411 may also reference standardized attention span profiles 415. In such implementations, the standardized attention span profiles 415 may include average or expected attention span profiles for a student user 501 based on general characteristics of the student user. For example, the standardized attention span profiles 415 may include base level or minimum attention span based on the student user's grade level and/or age. In some examples, the standardized attention span profiles can include layout specifications (e.g., text section lengths, and intervention point frequency, etc.) and supplemental educational content associated with specific attention span categories, attention span times, subject matter, or learning style. The attention span assessor 411 can then augment the standardized attention span profiles 415 based on the instructor-reported assessment 503, the self-reported student user assessments 503, and/or testing results to generate an attention span profile specific to a particular student user 501.

The attention span profile 440 can then be sent to the custom document generator 420. As shown, the custom document generator 420 can access original educational content 423 and supplemental material 425. The original educational content 423 can include electronic copies of textbooks, lesson books, literature, periodicals, reference books, and the like. Based on an attention span profile 440 for a particular student user 501, the custom document generator 420 can generate sections 141 of variable length 145 of the original educational content 423 to generate a custom educational document 441 for the particular student user 501. In some examples, the custom document generator 420 may also intersperse intervention points 150 among the sections 141 that include various types of supplemental educational material 110.

A custom educational document 441 can be provided to the specific student user 501 for whom it was created. For example, custom educational document 441-1, a printed or electronic version, can be provided to student user 501-1 to use. Based on the performance of student user 501-1 in comprehending and/or retaining the original educational content 423 from the custom educational document 441-1, the learning assessor 430 can generate the student user learning experience feedback 443.

In implementations in which the custom hybrid educational document includes electronic supplemental material accessible using a computing device 120, it is possible to determine the amount of time that a student spent reading the intervening section 141 of educational content text 140. Such information can be included in the student user learning experience feedback 443.

For example, the computing device 120 can determine the time a student user 501 finishes one intervention point 150 and the time that same student user 501 begins the next intervention point 150. This elapsed time between the end time of one intervention point 150 and the start time of the subsequent intervention point 150 can be interpreted by the computing device 120 and/or the learning assessor 430 as the time it took the student user 501 to read the intervening section 141 of the educational content text 140.

The time the student user took to read the intervening section 141 can then be compared to the time that the student user 501 was expected to take. Based on the caparison, the computing device 120 or the learning assessor 430 can evaluate the student users attention span and/or reading speed. For example, if the student demonstrates good comprehension and retention based on a faster than expected reading time of intervening section 141, then the learning assessor 430 can determine that the student user's reading speed has increased with no loss of attention. In an alternative example, the learning assessor 430 can determine that the time between successive intervention points 150 is longer than expected for a particular student user 150 and the demonstrated comprehension and/or retention is poor. In such scenarios, the information included in the student user learning experience feedback 443 can indicate a decrease in reading speed and a loss of attention.

The learning assessor 430 can also analyze test results to generate student user learning experience feedback 443. To evaluate the overall performance of the student user 501 with respect to a particular educational content text 140 (e.g., a text book or education lesson plan), in whole or in part, the learning assessor 430 can evaluate tests given to the student user 501 after various periods of time after the student user 501 completes the some or all of the sections 141. For example, learning assessor 430 can give the student user 501 an exam or quiz that includes some number of questions (e.g., 10 questions) immediately (e.g., approximately 5 minutes) after completing some number of sections 141. The learning assessor 430 can then give the student user 501 another exam or quiz at a later time (e.g., 45 minutes) after completing the sections 141 with questions covering sections 141 earlier and later in the educational content text 140. The sequence and difficulty of the questions can be randomized. Based on the results, the learning assessor 430 can determine the length of attention span for this student in the subject matter of the educational content text 140. For instance, a good grade for the questions relating to the first half of the educational content text 140 and deteriorating results for the later part of the educational content text 140 can indicate specific educational strengths and weaknesses relating to comprehension and retention.

The learning assessor 430 can analyze or average the test results across several educational content text 140 sets. The analysis of the test results can be included in the student user learning experience feedback 443. In such implementations, the raw and/or the analyzed test results can be included in the student user learning experience feedback 443.

The attention span assessor 411 can use student user learning experience feedback 443 to update the student user attention span profile 440-1 in the student user records 413 corresponding to student user 501-1. In particular, the attention span assessor 411 can update an attention span time in the student user attention span profile 440-1 corresponding to a subject matter type associated with the custom educational document 441-1.

The custom document generator 420 can then generate an updated version of the custom educational document 441-1 response to the updated student user attention span profile 440-1.

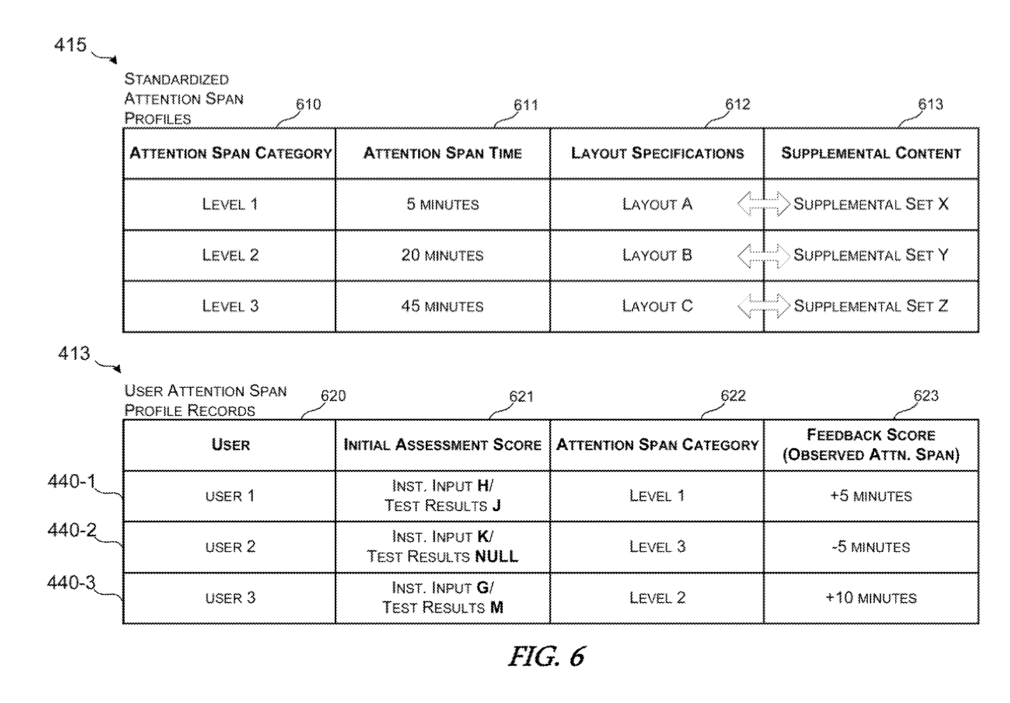

FIG. 6 depicts examples of standardized attention span profiles 415 and student user records 413. As shown, a standardized attention span profile 415 can include an identifier, such as attention span category 610 or an attention span time 611, associated with layout specifications 612, and identifiers supplemental educational content 613.

Student user records 413 can include a student user'identifier 620 associated with an initial assessment score 621, an attention span category 622, and, optionally, a feedback score 623. The initial assessment score 621 can include reported attention span assessments, such as self-reported and instructor-reported attention span assessment scores. In some examples, the initial assessment score 621 can also include test results.

Based on the information in the initial assessment score 621 data, the attention span assessor 411 can generate the attention span category 622. The attention span category 622 can be used to reference a corresponding standardized attention span profile 415 with a matching attention span category and use it as a template or baseline for generating a customized hybrid educational document for the student user 501.

Student user records 413 can also include feedback scores 623. Such feedback score can be based on test performance or feedback received directly from the student user 501. The attention span profile 440 generated by the attention span assessor 411, can be augmented based on the feedback score 623. For example, if the feedback score 623 is +5 minutes, then the length 145 of the sections 141 of the educational content 140 can be increased to account for the additional five minutes of attention span for the student user 501. On the other hand, if the feedback score 623 is negative, for example −5 minutes, then the length 145 of the sections 141 can be decreased to account for the diminished attention span of the student user 501 while reading the corresponding educational content text.

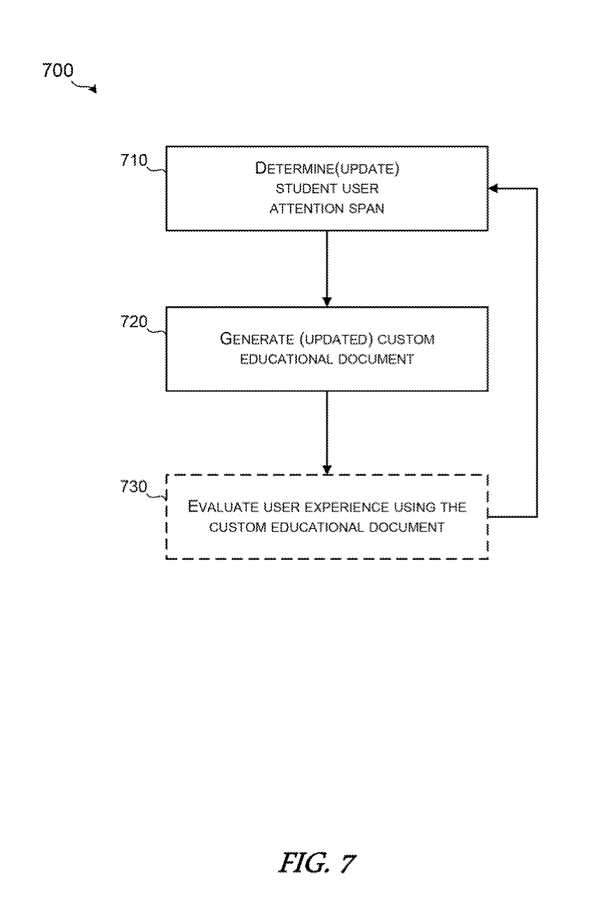

FIG. 7 is a flowchart of a method 700 for providing student user specific custom hybrid educational documents. As shown, method 700 can include box 710, in which the computing system implementing the functionality of the hybrid learning customizer 400, can determine the user attention span for a particular student user. The attention span can be determined as a period of time based on subjective and objective attention span data associated with the student user. Subjective attention span data can include self-reported and instructor-reported attention span times. Objective attention span data may include test results.

At box 720, hybrid learning customizer 400 can generate a custom educational document. As described herein, the custom educational document can include a combination and a specific layout of sections 141 of the educational content text 140 having various lengths 145 based on the attention span determined at box 710. In addition to the sections 141, the custom educational document can also include intervention points 150 interspersed according to the layout. The intervention points can include supplemental material (e.g., printed text and/or electronic multimedia content).

At box 730, hybrid learning customizer 400 can optionally evaluate the student user's experience using the custom educational document. Evaluation of the student user experience can include analysis of the student user's interaction with the supplemental material 110 in the intervention points 150. The hybrid learning customizer 400 can then use the evaluation of the student users experience to update the student user attention span, at box 710. Then, again at box 720, the hybrid learning customizer 400 can use the updated the student user attention span to generate an updated custom educational document. This process can continue until the student user has read some predetermined portion of the original educational content text.

These and other variations, modifications, additions, and improvements may fall within the scope of the appended claims(s). As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

What is claimed is:

1. A method comprising:
determining, by a computing system, an attention span profile associated with a particular student user; and
generating, by the computer system, a custom educational document in response to the attention span profile.

2. The method of claim 1 wherein determining the attention span profile comprises receiving student user input comprising an attention span score.

3. The method of claim 1 wherein determining the attention span profile comprises administering a test to the particular student user.

4. The method of claim 1 wherein generating custom educational document comprises:
determining a layout definition based on the attention span profile;
determining a set of educational content;
generating the custom educational document comprising the set of educational content arranged according to the layout definition.

5. The method of claim 1 wherein the custom educational document comprises:
a section of text having a length corresponding to the attention span profile; and
an intervention point comprising supplemental educational content associated with the layout definition.

6. The method of claim 5 wherein the supplemental educational content comprises an optical code or a hyperlink associated with an electronic file.

7. The method of claim 1 wherein the custom educational document comprises a physical document or an electronic file.

8. The method of claim 1 further comprising updating the attention span profile in response to student user input comprising student user feedback to the custom educational document.

9. A system comprising:
a processor; and
a non-volatile storage medium coupled to the processor and comprising instructions that, when executed by the processor, cause the processor to:
determine an attention span profile associated with a particular student user, and
generate a custom education document in response to the attention span profile.

10. The system of claim 9 wherein the instructions that cause the processor to determine the attention span profile comprise instructions that cause the processor to:
receive student user input comprising an attention span score; and
retrieve the attention span profile from a standardized library of attention span profile based the attention span score.

11. The system of claim 9 wherein the instructions that cause the processor to determine the attention span profile comprise instructions that cause the processor to administer a test to the particular student user and evaluate results of the test to generate the attention span profile.

12. The system of claim 9 wherein the instructions that cause the processor to generate a custom educational document further comprise instructions that cause the processor to:
determine a layout definition based on the attention span profile;
determine a set of educational content; and
generate the custom educational document comprising the set of educational content arranged according to the layout definition.

13. The system of claim 9 wherein the custom educational document comprises:
a section of text having a length corresponding to the attention span profile; and
an intervention point comprising supplemental educational content.

14. The system of claim 13 wherein the supplemental educational content comprises an optical code or a hyperlink associated with an electronic file.

15. The system of claim 9 wherein the instructions further cause the processor to:
generate an updated attention span profile based on the attention span profile and in response to student user input comprising student user feedback to the custom educational document; and
generate an updated custom educational document in response to the updated attention span profile.
